(19) United States
(12) Patent Application Publication
(10) Pub. No.: US 2012/0062149 A1
(43) Pub. Date: Mar. 15, 2012

(54) LIGHT EMITTING DIODE DRIVING INTEGRATED CIRCUIT

(76) Inventor: Chung-Wei Lin, Hsin-Chu (TW)

(21) Appl. No.: 13/219,720

(22) Filed: Aug. 29, 2011

(30) Foreign Application Priority Data
Sep. 13, 2010 (TW) 099130924

(51) Int. Cl. H05B 37/02

(52) U.S. Cl. 315/307

(57) ABSTRACT

A driving integrated circuit of light emitting diodes is used for driving at least one light emitting diode. The driving integrated circuit includes a current setting pin, a regulator circuit, and an adjuster. The driving integrated circuit sets a target current for a current flowing through the at least one light emitting diode according to an outflowing current of the current setting pin. The adjuster adjusts a target voltage according to the outflowing current. Then the regulator circuit provides a supply voltage for driving the light emitting diode so as to regulate a terminal voltage of the light emitting diode to the target voltage.

### BACKGROUND OF THE INVENTION

1. Field of the Invention

The present invention is related to a light emitting diode (LED) driving integrated circuit, and particularly to an LED driving integrated circuit that can dynamically change a terminal voltage of a series of light emitting diodes with a current flowing through the series of light emitting diodes.

2. Description of the Prior Art

In the prior art, after an LED driving integrated circuit utilizes a reference voltage generation circuit to generate a reference voltage, the LED driving integrated circuit can utilize the reference voltage to control a terminal voltage of a series of light emitting diodes through a closed loop formed by a boost converter. Thus, the terminal voltage of the series of light emitting diodes can be fixed to a target voltage, where the target voltage is used for providing a driving current for the series of light emitting diodes to operate normally.

However, after the target voltage is fixed, the target voltage can not be changed again. That is to say, the target voltage can not dynamically vary with an output current of the series of light emitting diodes adjusted by a user. Therefore, if the target voltage is too high, the LED driving integrated circuit may consume much energy and have lower energy efficiency; if the target voltage is too low, the driving integrated circuit may not operate normally.

### SUMMARY OF THE INVENTION

An embodiment provides a light emitting diode (LED) driving integrated circuit for driving at least one light emitting diode. The LED driving integrated circuit includes a current setting pin, a regulator circuit, and an adjuster. A reference current flowing through the current setting pin is used for setting a target current for a current flowing through the at least one light emitting diode. The regulator circuit is used for regulating a terminal voltage of the at least one light emitting diode to a target voltage, and providing a supply voltage for driving the at least one light emitting diode. The adjuster is used for adjusting a target voltage according to the reference current.

The present invention provides an LED driving integrated circuit. The LED driving integrated circuit generates a reference current and sets a target current flowing through a series of light emitting diodes according to an external resistor. Then, a regulator circuit regulates a terminal voltage of the series of light emitting diodes to the target voltage according to the reference current. Thus, the target voltage can vary dynamically with the target current, increase energy efficiency of the LED driving integrated circuit, and reduce heat generated by the LED driving integrated circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an LED driving integrated circuit according to an embodiment.

FIG. 2 is a diagram illustrating the target voltage dynamically varying with the target current.

### DETAILED DESCRIPTION

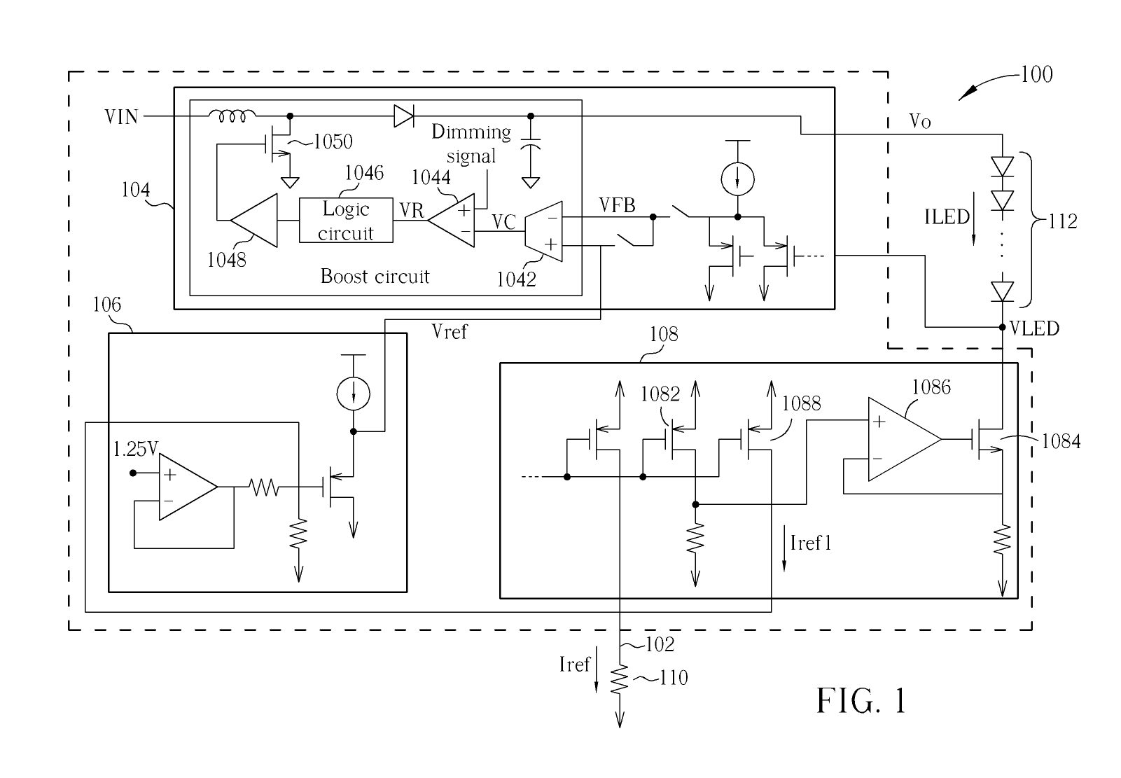

Please refer to FIG. 1. FIG. 1 is a diagram illustrating a light emitting diode (LED) driving integrated circuit 100 according to an embodiment. The LED driving integrated circuit 100 includes a current setting pin 102, a regulator circuit 104, and an adjuster 106. The current setting pin 102 is used for generating a reference current Iref through an external resistor 110. The driving integrated circuit 100 further includes a driving current generator 108 coupled to a series of light emitting diodes 112. The driving current generator 108 generates a target current ILED flowing through the series of light emitting diodes 112 according to the reference current Iref, transistors 1082, 1084, and an amplifier 1086. Then, the driving current generator 108 adds a first reference current Iref1 proportional to the reference current Iref to the adjuster 106 through a transistor 1088 included by the driving current generator 108. The adjuster 106 is coupled to the driving current generator 108 for generating a reference voltage Vref varying with the target current ILED according to the first reference current Iref1. The regulator circuit 104 is coupled to the adjuster 106. A compensator 1042 included by a boost circuit of the regulator circuit 104 is used for generating a compensation value VC according to the reference voltage Vref and a feedback voltage VFB. A comparator 1044 included by the boost circuit is used for generating a comparison result VR according to the compensation value VC and a dimming signal. The comparison result VR controls a switch 1050 through a logic circuit 1046 and a gate driving circuit 1048. Therefore, the regulator circuit 104 can regulate a terminal voltage of the series of light emitting diodes 112 to a target voltage VLED, and provide a supply voltage Vo for driving the series of light emitting diodes 112. Therefore, the target voltage VLED can vary dynamically with the target current ILED set by a user through the above mentioned loop.

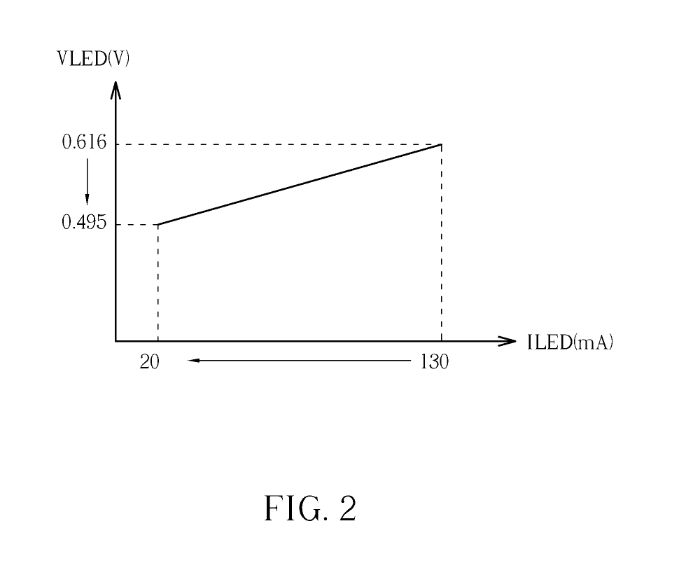

Please refer to FIG. 2. FIG. 2 is a diagram illustrating the target voltage VLED varying dynamically with the target current ILED. As shown in FIG. 2, a positive relationship exists between the target voltage VLED and the target current ILED. Therefore, when the target voltage VLED changes from 0.495V to 0.616V, the target current ILED changes form 20 mA to 130 mA.

To sum up, the LED driving integrated circuit generates the reference current and sets the target current flowing through the series of light emitting diodes according to the external resistor. Then, the regulator circuit regulates the terminal voltage of the series of light emitting diodes to the target voltage according to the reference current. Thus, the target voltage can vary dynamically with the target current to improve on the fixed target voltage in the prior art, increase energy efficiency of the LED driving integrated circuit, and reduce heat generated by the LED driving integrated circuit.

Those skilled in the art will readily observe that numerous modifications and alterations of the device and method may be made while retaining the teachings of the invention.

What is claimed is:

1. A light emitting diode (LED) driving integrated circuit for driving at least one light emitting diode, the LED driving integrated circuit comprising:
a current setting pin, wherein a reference current flowing through the current setting pin is used for setting a target current for a current flowing through the at least one light emitting diode;
a regulator circuit for regulating a terminal voltage of the at least one light emitting diode to a target voltage, and providing a supply voltage for driving the at least one light emitting diode; and
an adjuster for generating a reference voltage according to the reference current.

2. The LED driving integrated circuit of claim 1, wherein the current setting pin is coupled to an external resistor, and the external resistor is used for adjusting the reference current.

3. The LED driving integrated circuit of claim 1, further comprising:
a driving current generator for generating the target current according to the reference current.

4. The LED driving integrated circuit of claim 1, wherein the adjuster generates the reference voltage according to a first reference current proportional to the reference current.

5. The LED driving integrated circuit of claim 1, wherein the regulator circuit generates the target voltage according to the reference voltage.
